(19) United States
(12) Patent Application Publication
(10) Pub. No.: US 2012/0144649 A1
(43) Pub. Date: Jun. 14, 2012

(54) Pin Installation Assembly And Associated Machine And Method

(75) Inventors: Thangavel Ganesan, Tamil Nadu (IN); Ramaswamy Asoori, Tamil Nadu (IN); Saravanan Gopal, Tamil Nadu (IN); Senthil Kumar Kelambakkam Karunanidhi, Tamil Nadu (IN); Gokul Yadav Subramanian, Tamil Nadu (IN); Ravi Dhanya Kumar, Tamil Nadu (IN); Jijikumar John, Tamil Nadu (IN)

(73) Assignee: CATERPILLAR INDIA PRIVATE LIMITED, Chennai (IN)

(21) Appl. No.: 13/314,647

(22) Filed: Dec. 8, 2011

(30) Foreign Application Priority Data
Dec. 14, 2010 (IN) 2979/DEL/2010

(51) Int. Cl. B23P 11/00; B23P 19/00

(52) U.S. Cl. 29/428; 29/700

(57) ABSTRACT

A pin installation assembly disclosed herein includes a handle portion including a handle shank and a tip portion including a tip shank. The handle and tip shanks are configured to engage a pin.

### RELATION TO OTHER PATENT APPLICATION

This application claims priority to Indian Patent Application Number 2979/DEL/2010, filed Dec. 14, 2010.

### TECHNICAL FIELD

A pin installation assembly and an associated machine and method are disclosed. The pin installation assembly, machine, and method relate to connecting two components to one another using a pin.

### BACKGROUND

Effective tools and methods are critical elements of efficient machine assembly. Without them, the quality and capacity of production suffers. When the machines being assembled include multiple interdependent systems, subsystems, and components, assembly tools and methods are even more important, as inefficiencies are likely to compound and accumulate more quickly in such settings. Accordingly, improved tools and methods for assembling complex machines can provide significant production gains in efficiency, quality, and capacity.

During the assembly of trucks having bodies that may be articulated to dump material, attaching the truck bodies to the truck frames is a step that could benefit from improved assembly tools and methods. One of the mechanisms for assembling truck bodies to truck frames is disclosed in U.S. Pat. No. 4,480,871 to Fox, in which a dump bed stabilizer is described. The stabilizer in Fox includes a pair of elongated arm assemblies pivotally connected to one another in a complex manner to help prevent twisting of the truck body relative to the truck frame.

### SUMMARY OF THE DISCLOSURE

A pin installation assembly disclosed herein includes a handle portion including a handle shank and a tip portion including a tip shank. The handle and tip shanks are configured to engage a pin.

A machine disclosed herein includes a pin installation assembly including a handle portion, a tip portion, and a pin between the handle portion and the tip portion. The machine further includes first and second components configured to be connected to one another by the pin. The first and second components each define a component port.

A pin installation method disclosed herein includes providing at least one pin installation assembly. Each pin installation assembly includes a handle portion, a tip portion, and a pin between the handle portion and the tip portion. The method includes further providing first and second components configured to be connected to one another by the pin. The first and second components each define a component port. The method further includes substantially aligning the component port defined by the first component with the component port defined by the second component and inserting the at least one pin installation assembly through the aligned component ports of the first and second components.

### BRIEF DESCRIPTION OF THE DRAWINGS

FIG. 1 is a simplified and partially exploded perspective view of a truck with a truck body exploded above a truck frame;

FIG. 2 is a simplified and fragmentary perspective view of the truck shown in FIG. 1 illustrating the vicinity of hinge joints between the truck body and the truck frame;

FIG. 3A is an exploded view of a pin installation tool according to an embodiment of the invention;

FIG. 3B is a perspective view of the pin installation tool shown in FIG. 3A after being assembled;

FIG. 4A is a simplified and fragmentary perspective view of the truck shown in FIG. 1 illustrating the vicinity of lift joints between the truck body and the truck frame;

FIG. 4B is the view shown in FIG. 4A illustrating partial insertion of the pin installation assembly shown in FIGS. 3A and 3B according to an embodiment of the invention;

FIG. 5 is a simplified and fragmentary perspective view of the truck shown in FIG. 1 illustrating the vicinity of the lift joints shown in FIGS. 4A and 4B and full insertion of two of the pin installation assemblies shown in FIGS. 3A and 3B according to an embodiment of the invention; and

FIG. 6 is an exploded view of a pin installation tool according to another embodiment of the invention.

### DETAILED DESCRIPTION

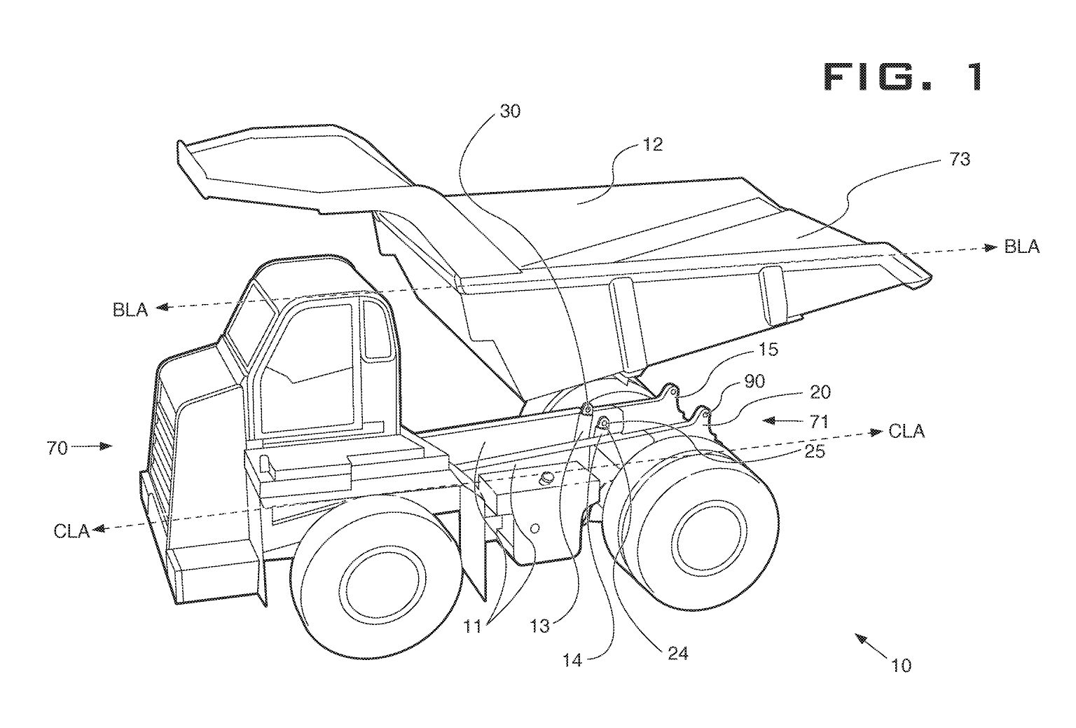

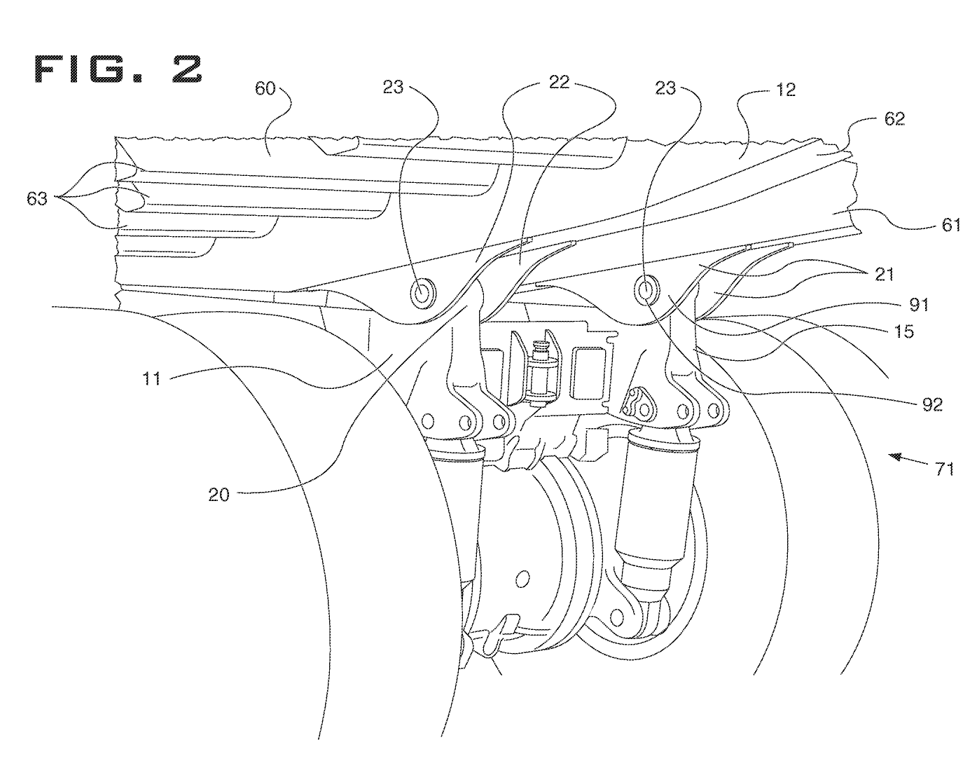

A truck is shown broadly at reference numeral 10 in FIG. 1. The truck 10 includes a front end 70, a back end 71, an overall chassis 72 including a frame 11 extending from the back end 71 toward the front end 70, a body 12 configured for mounting on the frame 11 and including a bed 73, and first and second hydraulic lift cylinders 13, 14 attached to the frame 11 and configured for mounting to the body 12. The frame 11 includes first and second hinge points 15, 20 proximal to the back end 71 of the truck 10 for mounting the body 12 to the frame 11 in a manner that enables articulation of the body 12 relative to the frame 11. The hinge points 15, 20 each define a port 90 for receiving a hinge pin 23 (FIG. 2). As shown in FIG. 2, first and second hinge brackets 21, 22 are mounted on the body 12 and are configured for receiving the first and second hinge points 15, 20 of the frame, respectively. Each of the hinge brackets 21, 22 includes two plates 91, and each of the plates 91 defines a port 92 for receiving a pin such as the illustrated hinge pin 23. The plates 91 in each of the hinge brackets 21, 22 are spaced apart from one another such that one of the hinge points 15, 20 may be received therebetween. The ports 92 of the two plates 91 in each of the hinge brackets 21, 22 are substantially aligned with one another such that the hinge pin 23 may be inserted through both of the ports 92.

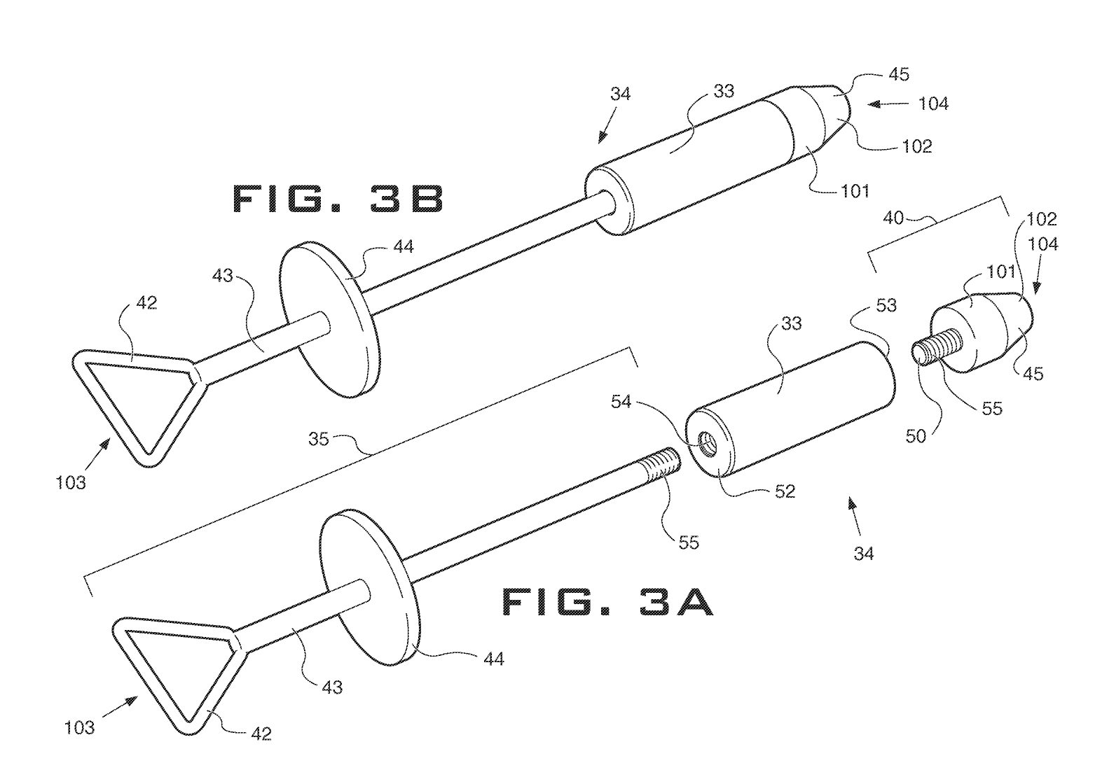

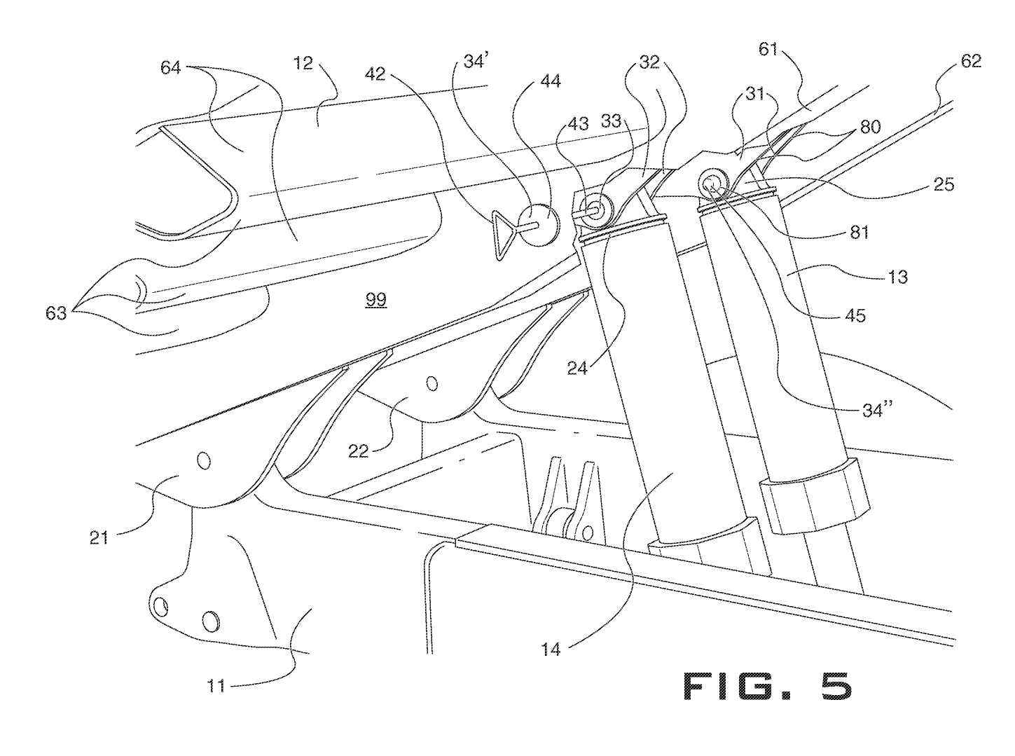

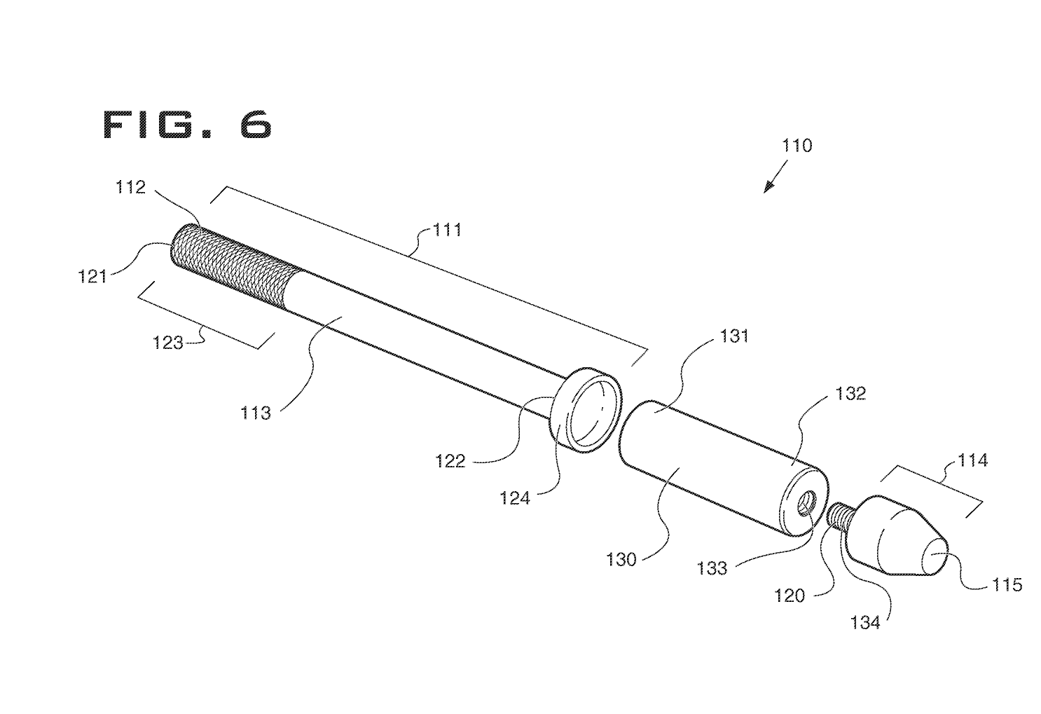

During operation of the truck 10, the body 12 may be moved between a rest position and a dump position on command, for instance to dump material (not shown) out of the bed 73 or as otherwise needed for a given application. In the rest position, a longitudinal axis “BLA” defined by the body 12 is in substantially parallel relation to a longitudinal axis “CLA” defined by the chassis 72, whereas in the dump position the longitudinal axis “BLA” of the body 12 is in substantially non-parallel relation to the longitudinal axis “CLA” of the chassis 72. When moving between the rest position and the dump position, the body 12 pivots about the hinge pins 23. However, in order to move the body 12 between positions, the body 12 must also be mounted to the lift cylinders 13, 14, as it is the actuation of the lift cylinders 13, 14 that moves the body 12. The lift cylinders 13, 14 each include a rod 24 having a rod end 25. Each rod end 25 defines a eye 30. First and second lift brackets 31, 32 (FIG. 5) are mounted on the body 12 and are configured for receiving the rod ends 25 of the first and second lift cylinders 13, 14, respectively. The rod ends 25 of the first and second lift cylinders 13, 14 are mounted to the first and second lift brackets 31, 32 using pins such as the illustrated lift pins 33 (FIGS. 3A and 3B).

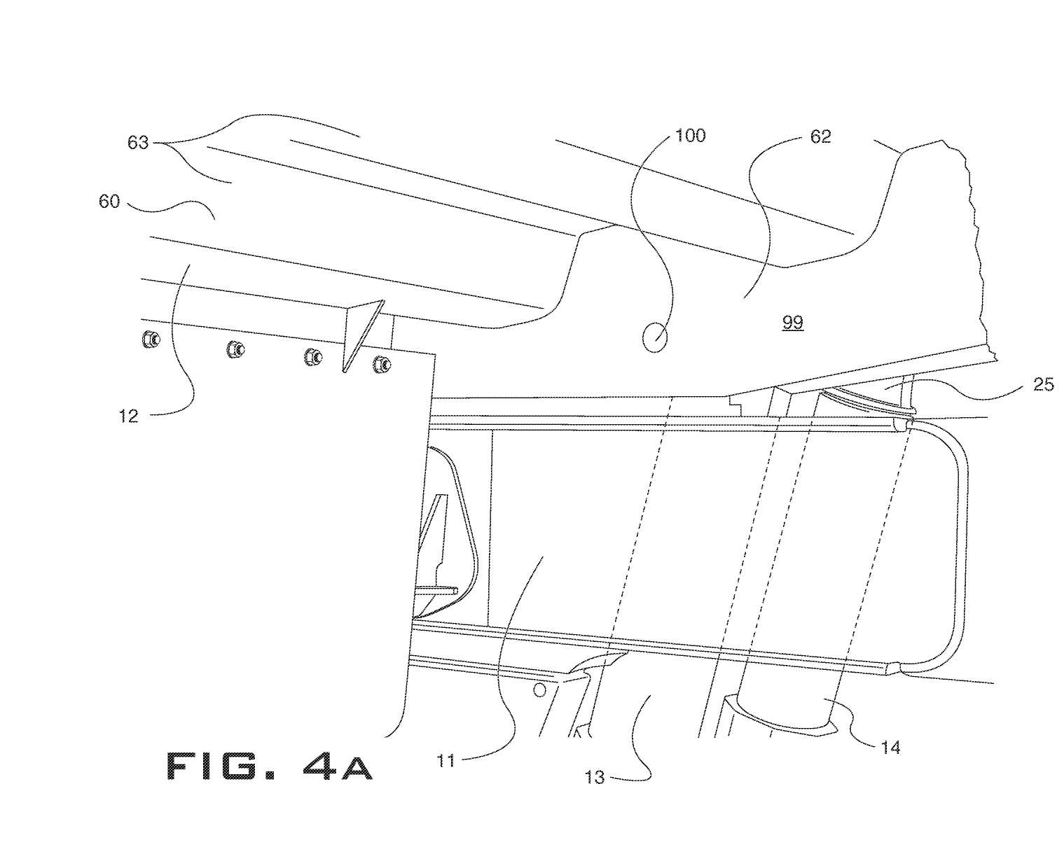

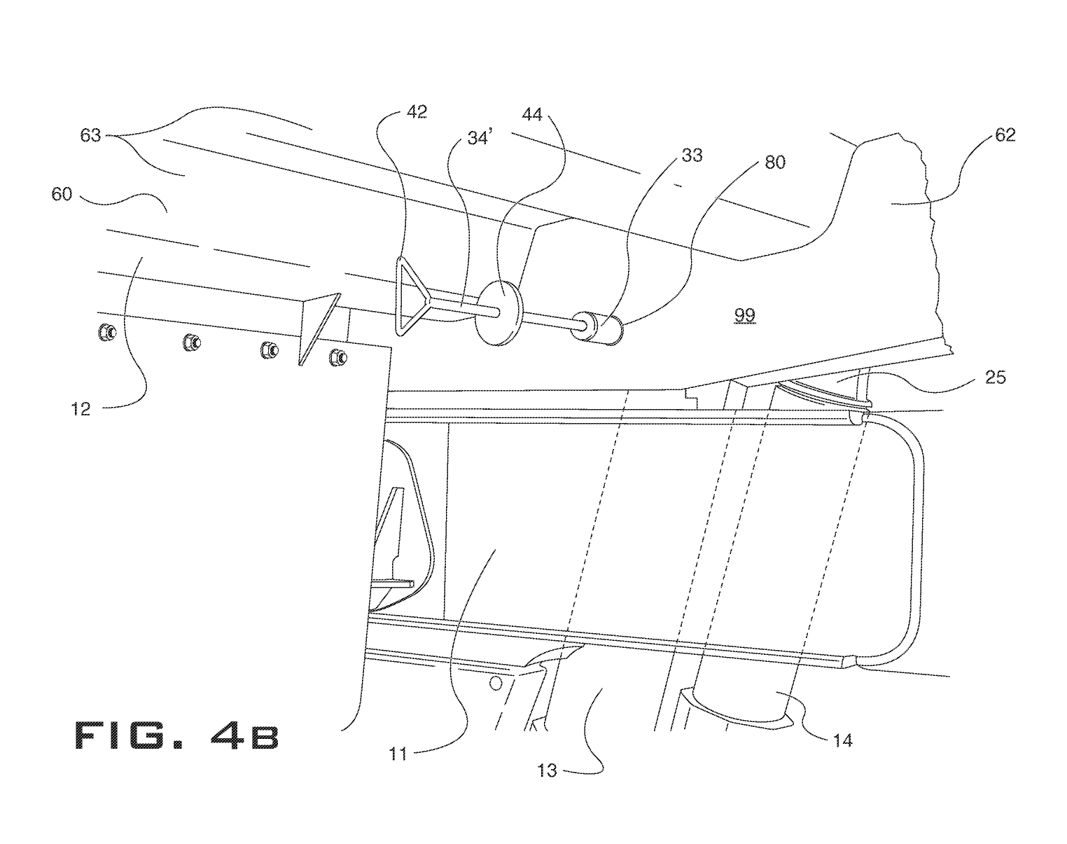

In the illustrated embodiment, an underside 60 of the body 12 includes first and second longitudinal, substantially parallel support ribs 61, 62 (FIG. 5) in substantially perpendicular relation with a plurality of lateral, substantially parallel support ribs 63. The first and second hinge brackets 21, 22 are mounted to the first and second longitudinal ribs 61, 62, respectively, while the first and second lift brackets 31, 32 are mounted in spaced apart relation to one another between the longitudinal ribs 61, 62 and between a pair of adjacent ribs 64 among the plurality of lateral ribs 63. Each of the lift brackets 31, 32 includes two plates 80, and each of the plates 80 defines a port 81 for receiving a lift pin 33 (FIGS. 3A, 3B, and 4B). The plates 80 in each of the lift brackets 31, 32 are spaced apart from one another such that the rod end 25 of one of the lift cylinders 13, 14 may be received therebetween. The ports 81 of the two plates 80 in each of the lift brackets 31, 32 are substantially aligned with one another such that the lift pin 33 may be inserted through both of the ports 81. Each of the first and second longitudinal ribs 61, 62 includes an outer surface 99 that defines a port 100 (FIG. 4A) through which one of the lift pins 33 may be inserted. The ports 100 defined by the first and second longitudinal ribs 61, 62 are positioned to substantially align with the eyes 30 defined by the rod ends 25 of the first and second lift cylinders 13, 14, respectively, when the rods 24 of the lift cylinders 13, 14 are each in a substantially fully retracted position.

An embodiment of a pin installation assembly 34 is shown in FIGS. 3A and 3B in dissembled and assembled form, respectively. The pin installation assembly 34 includes a handle portion 35, a tip portion 40, and the lift pin 33 between the handle portion 35 and the tip portion 40. The handle portion 35 includes a handle 42, a handle shank 43 connected to the handle 42, and a stop such as the illustrated plate 44 mounted on the handle shank 43. The tip portion 40 includes a tip 45 and a tip shank 50 connected to the tip 45. The tip 45 includes a substantially cylindrical portion 101 in proximal relation to the tip shank 50 and a substantially frustoconical portion 102 in distal relation to the tip shank 50. The pin installation assembly 34 includes first and second opposing ends 103, 104, with the handle 42 of the handle portion 35 at the first end 103 and the substantially frustoconical portion 102 of the tip 45 at the second end 104. The lift pin 33 includes first and second ends 52, 53, each defining a port 54. The ports 54 of the first and second ends 52, 53 are configured to receive the handle shank 43 and the tip shank 50, respectively. Specifically, in the disclosed embodiment, the ports 54 are internally threaded and the handle and tip shanks 43, 50 each include a threaded portion 55 having external threads corresponding to internal threads in the ports 54 defined by the lift pin 33.

Another embodiment of a pin installation assembly 110 is shown in FIG. 6. Like the pin installation assembly 34 in FIGS. 3A and 3B, the pin installation assembly 110 in FIG. 6 includes a handle portion 111 having a handle 112 and a handle shank 113, a tip portion 114 having a tip 115 and a tip shank 120, and a pin 130 between the handle portion 111 and the tip portion 114. The handle shank 113 includes first and second ends 121, 122. The handle 112 is a knurled or otherwise textured region 123 of the handle shank 113 configured to enable a user to grip the handle shank 113 securely. The textured region 123 is proximal to the first end 121 of the handle shank 113. The second end 122 of the handle shank 113 terminates such that a pin socket 124 is defined thereby. The outermost diameter of the socket 124 is greater than the outermost diameter of the remainder of the handle shank 113 and may be substantially equal to the innermost diameter of the each of the ports 100 defined by the outer surfaces 99 (one shown) of the first and second longitudinal ribs 61, 62 of the body 12. The pin 130 of the pin installation assembly 110 includes a first end 131 proximal to the handle portion 111 and a second end 132 proximal to the tip portion 114. The socket 124 of the handle portion 111 is configured to receive the first end 131 of the pin 130. The second end 132 of the pin 130 defines a port 133 configured to receive the tip shank 120. Specifically, in the disclosed embodiment, the port 133 is internally threaded and the tip shank 120 includes a threaded portion 134 having external threads corresponding to the internal threads in the port 133 defined by the pin 130.

### INDUSTRIAL APPLICABILITY

The pin installation assembly 34 is employed in the following pin installation method utilized during assembly and/or maintenance of the truck 10. The lift cylinders 13, 14 are actuated as necessary to ensure that the rods 24 of the cylinders 13, 14 are each in a substantially fully refracted position. The body 12 is suspended from and/or the weight of the body 12 is at least partially borne by a crane, a system of pulleys, or other suspending and/or weight bearing mechanism. If the body 12 is not already hinged to the frame 11, the body 12 is then positioned above the frame 11 and lowered toward the frame 11 until the first and second hinge points 15, 20 on the body 12 are received between the plates 91 of the first and second hinge brackets 21, 22, respectively, and the ports 90 defined by the first and second hinge points 15, 20 substantially align with the ports 92 defined by the plates 91 of the first and second hinge brackets 21, 22, respectively. The hinge pins 23 are then installed to connect the first and second hinge brackets 21, 22 to the first and second hinge points 15, 20, respectively, in a manner that enables the body 12 to articulate relative to the frame 11 as needed for the body 12 to move from the rest position to the dump position and vice versa.

The body 12 is then placed or maintained in the rest position, such that the rod ends 25 of the first and second lift cylinders 13, 14 are received between the plates 80 of the first and second lift brackets 31, 32, respectively, and the eyes 30 defined by the rod ends 25 of the first and second lift cylinders 13, 14 are substantially aligned with the ports 81 defined by the plates 80 of the first and second lift brackets 31, 32, respectively. First and second fully assembled pin installation assemblies 34′, 34″ (FIG. 5) are obtained, each configured in accordance with the pin installation assembly 34 shown in FIGS. 3A and 3B, including the lift pins 33 thereon. The first and second pin installation assemblies 34′, 34″ are then inserted through (1) the ports 100 (one shown) defined by the outer surfaces 99 (one shown) of the first and second longitudinal ribs 61, 62 of the body 12, respectively, (2) the ports 81 defined by the plates 80 of the first and second lift brackets 31, 32, respectively, and (3) the eyes 30 of the rod ends 25 of the first and second lift cylinders 13, 14 residing between the plates 80 of the first and second lift brackets 31, 32, respectively. Such insertion is completed when the plates 44 of the pin installation assemblies 34′, 34″ substantially engage the outer surfaces 99 of the first and second longitudinal ribs 61, 62 of the body 12. The substantially frustoconical portions 102 of the tips 45 of the pin installation assemblies 34 assist with insertion of the pin installation assemblies 34 through the ports 100, 81 and the eyes 30 and help ensure that the ports 100, 81 and the eyes 30 are substantially aligned such that, after insertion of the pin installation assemblies 34′, 34″ is completed, the lift pins 33 of the pin installation assemblies 34′, 34″ extend through the ports 81 of the lift brackets 31, 32 and the eyes 30 of the lift cylinders 13, 14.

After insertion of the pin installation assemblies 34′, 34″ the lift cylinders 13, 14 may be actuated to move the body 12 from the rest position to the dump position. A technician may then secure the lift pins 33 with securements such as lock plates, bolts, washers, and/or other structures known to those of ordinary skill in the art. The lift cylinders 13, 14 may then be actuated again to return the body to the rest position. Optionally, after insertion of the pin installation assemblies 34′, 34″ is completed or after the lift pins 33 have been secured, the handle portions 35 and/or the tip portions 40 of the pin installation assemblies 34′, 34″ may be removed from the pin installation assemblies 34′, 34″ by grasping and unscrewing the handle portions 35 and/or the tip portions 40 from the lift pins 33. Alternatively, the handle portions 35 and/or the tip portions 40 may be left in place on the pin installation assemblies 34′, 34″ in order to facilitate future maintenance.

The alternate embodiment of the pin installation assembly 110 (FIG. 6) may be employed in the pin installation method described above by varying the method as follows. The first and second pin installation assemblies (not shown) are each configured in accordance with the pin installation assembly 110, including the pin 130 thereon. The insertion of each pin installation assembly 110 is completed when the textured region 123 of the handle shank 113 reaches the corresponding outer surface 99 of the corresponding longitudinal rib 61, 62 of the body 12 of the truck 10. In this way, the textured region 123 of the handle shank 113 not only forms the handle 112 of the pin installation assembly 110 but also provides a visual indicator showing when insertion of each pin installation assembly 110 is completed. Further, due to the above-described variation in the diameter of the handle portion 111 of the pin installation assembly 110, after the pin 130 and the socket 124 of each pin installation assembly 110 have been inserted through the corresponding port 100 in the corresponding longitudinal rib 61, 62 of the body 12 of the truck 10, the corresponding lift cylinder 13, 14 is visible through the port 100, thereby enabling easier and more accurate alignment and installation of the pin 130. Moreover, as the handle portion 111 of each pin installation assembly 110 is not threaded onto the corresponding pin 130, when installation of the each pin 130 is complete, the corresponding handle portion 111 is removed from the pin installation assembly 110 merely by being pulled back through the port 100.

The specific embodiments disclosed herein are provided by way of example and not by way of limitation. For instance, more broadly, the above pin installation assemblies and methods may be utilized to connect first and second components of a machine to one another with a pin. The first and second components of the machine may each include one or more component ports and the respective component ports of the components may be aligned with one another to receive the pin installation assembly. In addition, the handle, the handle portion in general, the tip, and/or the tip portion in general may also be restructured, relocated, or otherwise customized as needed.

A pin installation assembly and an associated machine and method is disclosed. Many variations of the disclosed embodiments may be practiced without departing from the scope of the invention, which is set forth solely in the following claims.

What is claimed is:

1. A pin installation assembly, comprising:
a handle portion including a handle shank;
a tip portion including a tip shank;
the handle and tip shanks being configured to engage a pin.

2. The assembly of claim 1, wherein the tip portion further includes a tip having a substantially cylindrical portion and a substantially frustoconical portion.

3. The assembly of claim 1, further comprising a pin with first and second ends, wherein the first end is configured to engage the handle shank and the second end defines a port configured to receive the tip shank.

4. The assembly of claim 3, wherein the tip portion further includes a tip having a substantially cylindrical portion and a substantially frustoconical portion.

5. The assembly of claim 4, wherein the substantially cylindrical portion of the tip is in proximal relation to the tip shank and the substantially frustoconical portion of the tip is in distal relation to the tip shank.

6. The assembly of claim 1, further comprising a visual indicator on the handle shank.

7. The assembly of claim 6, wherein the visual indicator is a knurled region of the handle shank.

8. A machine, comprising:
a pin installation assembly including a handle portion, a tip portion, and a pin between the handle portion and the tip portion;
first and second components configured to be connected to one another by the pin, the first and second components each defining a component port.

9. The machine of claim 8, wherein the tip portion of the pin installation assembly includes a tip having a substantially cylindrical portion and a substantially frustoconical portion.

10. The machine of claim 8, wherein the first component is a body of a truck and the second component is a hydraulic cylinder.

11. The machine of claim 10, wherein the hydraulic cylinder is mounted on a frame of the truck and is configured to move the body of the truck between a rest position and a dump position.

12. The machine of claim 10, wherein the hydraulic cylinder includes a rod having a rod end defining an eye, the body of the truck includes an underside having a rib defining a port configured for alignment with the eye defined by the rod end, and the pin is configured for insertion through the port and the eye.

13. The machine of claim 12, wherein the pin installation assembly further includes a visual indicator on the handle shank.

14. A pin installation method, comprising:
providing at least one pin installation assembly, each pin installation assembly including a handle portion, a tip portion, and a pin between the handle portion and the tip portion;
further providing first and second components configured to be connected to one another by the pin, the first and second components each defining a component port;
substantially aligning the component port defined by the first component with the component port defined by the second component; and
inserting the at least one pin installation assembly through the aligned component ports of the first and second components.

15. The method of claim 14, wherein in the pin installation assembly provided in the providing step, the handle portion includes a handle shank, the tip portion includes a tip shank, and the pin includes first and second ends, the first end being configured to engage the handle shank and the second end defining a port configured to receive the tip shank.

16. The method of claim 15, further comprising assembling each pin installation assembly such that the tip shank is received by the port defined by the second end of the pin.

17. The method of claim 14, wherein the first component is a body of a truck and the second component is a hydraulic cylinder mounted on a frame of the truck.

18. The method of claim 14, wherein:
first and second pin installation assemblies are provided in the providing step;
the component port defined by each of the first and second components in the further providing step is a first component port and the first and second components each further define a second component port;
the substantially aligning step includes aligning the first component ports of the first and second components with one another and aligning the second component ports of the first and second components with one another; and
the inserting step includes inserting the first and second pin installation assemblies through the aligned first component ports and the aligned second component ports, respectively.

19. The method of claim 18, wherein the first component is a body of a truck and the second component is a hydraulic cylinder mounted on a frame of the truck.

20. The method of claim 19, wherein in each of the pin installation assemblies provided in the providing step, the handle portion includes a handle shank, the tip portion includes a tip shank, and the pin includes first and second ends, the first end being configured to engage the handle shank and the second end defining a port configured to receive the tip shank, the method further comprising assembling each of the pin installation assemblies such that the tip shank is received by the port defined by the second end of the pin.
